(19) United States
(12) Patent Application Publication
(10) Pub. No.: US 2020/0245373 A1
(43) Pub. Date: Jul. 30, 2020

(54) TWO-STEP RANDOM ACCESS CHANNEL (RACH) IN NEW RADIO (NR) NETWORKS AND SYSTEMS

(71) Applicant: Intel Corporation, Santa Clara, CA (US)

(72) Inventors: Gang Xiong, Portland, OR (US); Yongjun Kwak, Portland, OR (US); Sergey Sosnin, Zavolzhie NIZ (RU); Guotong Wang, Beijing (CN); Yushu Zhang, Beijing (CN)

(21) Appl. No.: 16/783,335

(22) Filed: Feb. 6, 2020

Related U.S. Application Data
(60) Provisional application No. 62/805,524, filed on Feb. 14, 2019.
(60) Provisional application No. 62/810,125, filed on Feb. 25, 2019.
(60) Provisional application No. 62/829,585, filed on Apr. 4, 2019.
(60) Provisional application No. 62/846,475, filed on May 10, 2019.
(60) Provisional application No. 62/931,007, filed on Nov. 5, 2019.

(51) Int. Cl. H04W 74/08; H04W 72/04; H04L 27/26

(52) U.S. Cl. CPC H04W 74/0833; H04L 27/2605; H04W 72/04

(57) ABSTRACT

Embodiments of the present disclosure describe methods, apparatuses, storage media, and systems for generation, transmission, and reception of a message A (MsgA) with respect to a two-step random access channel (RACH) procedure in new radio (NR) networks and/or communications. Various embodiments describe how to generate the MsgA that includes a physical random access channel (PRACH) occasion and a MsgA physical uplink shared channel (PUSCH) resource. Certain association, rules, and/or correlation may apply herein. Further, corresponding demodulation reference signal (DMRS) sequence generation is illustrated in accordance with various embodiments. Other embodiments may be described and claimed.

### CROSS REFERENCE TO RELATED APPLICATION

The present application claims priority to U.S. Provisional Patent Application No. 62/805,524, filed Feb. 14, 2019, entitled “Association between Physical Random Access Channel (PRACH) and MsgA Physical Uplink Shared Channel (PUSCH) for 2 Step Random Access Channel (RACH),” U.S. Provisional Patent Application No. 62/810,125, filed Feb. 25, 2019, entitled “Association between Physical Random Access Channel (PRACH) and MsgA Physical Uplink Shared Channel (PUSCH) for 2 Step Random Access Channel (RACH),” U.S. Provisional Patent Application No. 62/829,585, filed Apr. 4, 2019, entitled “On the Association between PRACH and MsgA PUSCH for 2 Step RACH,” U.S. Provisional Patent Application No. 62/846,475, filed May 10, 2019, entitled “Association between PRACH and MsgA PUSCH for 2 Step RACH,” and U.S. Provisional Patent Application No. 62/931,007, filed Nov. 5, 2019, entitled “On the Association between PRACH and MsgA PUSCH for 2 Step RACH,” all of which are hereby incorporated by references in their entirety.

### FIELD

Embodiments of the present invention relate generally to the technical field of wireless communications.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

Mobile communications have evolved significantly from voice systems at early stages to sophisticatedly integrated communication platforms as of today. The fifth generation (5G) new radio (NR) communications may provide information access and data sharing at various locations and times by various users and applications. NR may be aimed to be a unified network and/or system that is to meet various, sometimes may be conflicting, performance dimensions and services.

Conventionally, a four-step procedure has been used for contention based and/or contention free random access. In this approach, a user equipment (UE) may transmit physical random access channel (PRACH) in an uplink by randomly selecting one preamble signature, which may allow an access node (AN) to estimate the delay between the AN and UE for subsequent uplink timing adjustment. Subsequently, the AN may provide one or more feedback as random access response (RAR), which may carry timing advanced (TA) command information and uplink grant for the uplink transmission. However, this four-step procedure may introduce certain access latency. To reduce such access latency, a two-step procedure may be used to improve access performance. New approaches in this regard are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 schematically illustrates an example of a network comprising a UE and an AN in a wireless network, in accordance with various embodiments.

FIG. 2 illustrates example components of a device in accordance with various embodiments.

FIG. 3 illustrates a two-step RACH procedure, in accordance with various embodiments.

FIGS. 4A-4C illustrate some example associations/mappings between PRACH resource subset(s) and message A (MsgA) physical uplink shared channel (PUSCH) resource(s), in accordance with various embodiments.

FIGS. 5A-5C illustrate some example associations between PRACH resource subset(s) and MsgA PUSCH resource(s), in accordance with various embodiments.

FIG. 6 illustrates an example of MsgA PUSCH resource periodicity, in accordance with various embodiments.

FIG. 7A illustrates an operation flow/algorithmic structure to facilitate a process of generation and transmission of a MsgA with respect to the two-step RACH procedure by a UE in NR involved networks, in accordance with various embodiments. FIG. 7B illustrates an operation flow/algorithmic structure to facilitate the process of generation, transmission, and reception of a MsgA with respect to the two-step RACH procedure by the AN in NR involved networks, in accordance with various embodiments.

FIG. 8 illustrates hardware resources in accordance with some embodiments.

### DETAILED DESCRIPTION

In the following detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrases “A or B” and “A and/or B” mean (A), (B), or (A and B). For the purposes of the present disclosure, the phrases “A, B, or C” and “A, B, and/or C” mean (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include any combination of integrated circuits (for example, a field-programmable gate array (FPGA), an application specific integrated circuit (ASIC), etc.), discrete circuits, combinational logic circuits, system on a chip (SOC), system in a package (SiP), that provides the described functionality. In some embodiments, the circuitry may execute one or more software or firmware modules to provide the described functions. In some embodiments, circuitry may include logic, at least partially operable in hardware.

As earlier discussed, a two-step RACH procedure may be used instead of the conventional four-step RACH procedure to establish UE access to the network. Various embodiments herein provide mapping and/or association between physical random access channel (PRACH) and a message A (MsgA) physical uplink shared channel (PUSCH) in a two-step RACH procedure. This may allow an AN to detect the PRACH and decode the MsgA PUSCH based on corresponding rules of mapping and/or association. Further, corresponding demodulation reference signal (DMRS) configuration is discussed with respect to the associated MsgA PUSCH transmissions.

Embodiments described herein may include, for example, apparatuses, methods, and storage media for enabling the two-step RACH procedure in accordance with various rules of mapping and/or association among corresponding channels and/or signals.

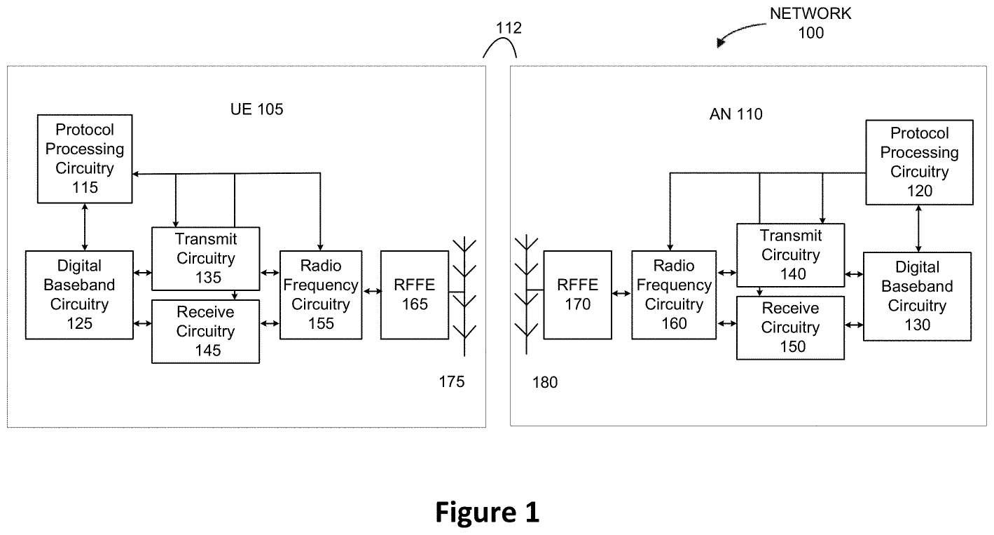

FIG. 1 schematically illustrates an example wireless network 100 (hereinafter “network 100”) in accordance with various embodiments herein. The network 100 may include a UE 105 in wireless communications with an AN 110. In some embodiments, the network 100 may be an NR network operating in an unlicensed spectrum. The UE 105 may be configured to connect, for example, to be communicatively coupled, with the AN 110. In this example, the connection 112 is illustrated as an air interface to enable communicative coupling, and can be consistent with cellular communications protocols such as a 5G NR protocol operating at mmWave and/or sub-6 GHz, a NR in unlicensed spectrum (NR-U), a Listen-before-Talk (LBT) protocol, a code-division multiple access (CDMA) network protocol, a Push-to-Talk (PTT) protocol, and the like.

When operating in unlicensed radio frequency spectrum bands, wireless devices such as the AN 110 and UE 105 may employ LBT procedures to ensure the channel is clear before transmitting data. In some cases, operations in unlicensed bands may be based on a carrier aggregation (CA) configuration in conjunction with CCs operating in a licensed band. Operations in unlicensed spectrum may include DL transmissions, UL transmissions, or both. Duplexing in unlicensed spectrum may be based on frequency division duplexing (FDD), time division duplexing (TDD) or a combination of both. Additionally or alternatively, a grant-free UL transmission may be used in the unlicensed spectrum to avoid quadruple contention.

The UE 105 is illustrated as a smartphone (for example, a handheld touchscreen mobile computing device connectable to one or more cellular networks), but may also comprise any mobile or non-mobile computing devices, such as a Personal Data Assistant (PDA), pager, laptop computer, desktop computer, wireless handset, customer premises equipment (CPE), fixed wireless access (FWA) device, vehicle mounted UE or any computing device including a wireless communications interface. In some embodiments, the UE 105 can comprise an Internet of Things (IoT) UE, which can comprise a network access layer designed for low-power IoT applications utilizing short-lived UE connections. An IoT UE can utilize technologies such as narrowband IoT (NB-IoT), machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An NB-IoT/MTC network describes interconnecting NB-IoT/MTC UEs, which may include uniquely identifiable embedded computing devices (within the Internet infrastructure), with short-lived connections. The NB-IoT/MTC UEs may execute background applications (for example, keep-alive message, status updates, location related services, etc.).

The AN 110 can enable or terminate the connection 112. The AN 110 can be referred to as a base station (BS), NodeB, evolved-NodeB (eNB), Next-Generation NodeB (gNB or ng-gNB), NG-RAN node, cell, serving cell, neighbor cell, and so forth, and can comprise ground stations (for example, terrestrial access points) or satellite stations providing coverage within a geographic area.

The AN 110 can be the first point of contact for the UE 105. In some embodiments, the AN 110 can fulfill various logical functions including, but not limited to, radio network controller (RNC) functions such as radio bearer management, uplink and downlink dynamic radio resource management and data packet scheduling, and mobility management.

In some embodiments, a downlink resource grid can be used for downlink transmissions from the AN 110 to the UE 105, while uplink transmissions can utilize similar techniques. The grid can be a time-frequency grid, called a resource grid or time-frequency resource grid, which is the physical resource in the downlink in each slot. Such a time-frequency plane representation is a common practice for orthogonal frequency division multiplexing (OFDM) systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UE 105. The physical downlink control channel (PDCCH) may carry information about the transport format and resource allocations related to the PDSCH channel, among other things. It may also inform the UE 105 about the transport format, resource allocation, and hybrid automatic repeat request (HARQ) information related to the uplink shared channel. Typically, downlink scheduling (assigning control and shared channel resource blocks to the UE 105 within a cell) may be performed at the AN 110 based on channel quality information fed back from any of the UE 105. The downlink resource assignment information may be sent on the PDCCH used for (for example, assigned to) the UE 105.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition.

Some embodiments may use concepts for resource allocation for control channel information that are an extension of the above-described concepts. For example, some embodiments may utilize an enhanced physical downlink control channel (ePDCCH) that uses PDSCH resources for control information transmission. The ePDCCH may be transmitted using one or more enhanced control channel elements (ECCEs). Similar to the above, each ECCE may correspond to nine sets of four physical resource elements known as enhanced resource element groups (EREGs). An ECCE may have other numbers of EREGs in some situations.

As shown in FIG. 1, the UE 105 may include millimeter wave communication circuitry grouped according to functions. The UE 105 may include protocol processing circuitry 115, which may implement one or more of layer operations related to medium access control (MAC), radio link control (RLC), packet data convergence protocol (PDCP), radio resource control (RRC) and non-access stratum (NAS). The protocol processing circuitry 115 may include one or more processing cores (not shown) to execute instructions and one or more memory structures (not shown) to store program and data information.

The UE 105 may further include digital baseband circuitry 125, which may implement physical layer (PHY) functions including one or more of HARQ functions, scrambling and/or descrambling, coding and/or decoding, layer mapping and/or de-mapping, modulation symbol mapping, received symbol and/or bit metric determination, multi-antenna port pre-coding and/or decoding, which may include one or more of space-time, space-frequency or spatial coding, reference signal generation and/or detection, preamble sequence generation and/or decoding, synchronization sequence generation and/or detection, control channel signal blind decoding, and other related functions.

The UE 105 may further include transmit circuitry 135, receive circuitry 145, radio frequency (RF) circuitry 155, and RF front end (RFFE) 165, which may include or connect to one or more antenna panels 175.

In some embodiments, RF circuitry 155 may include multiple parallel RF chains or branches for one or more of transmit or receive functions; each chain or branch may be coupled with one antenna panel 175.

In some embodiments, the protocol processing circuitry 115 may include one or more instances of control circuitry (not shown) to provide control functions for the digital baseband circuitry 125 (or simply, “baseband circuitry 125”), transmit circuitry 135, receive circuitry 145, radio frequency circuitry 155, RFFE 165, and one or more antenna panels 175.

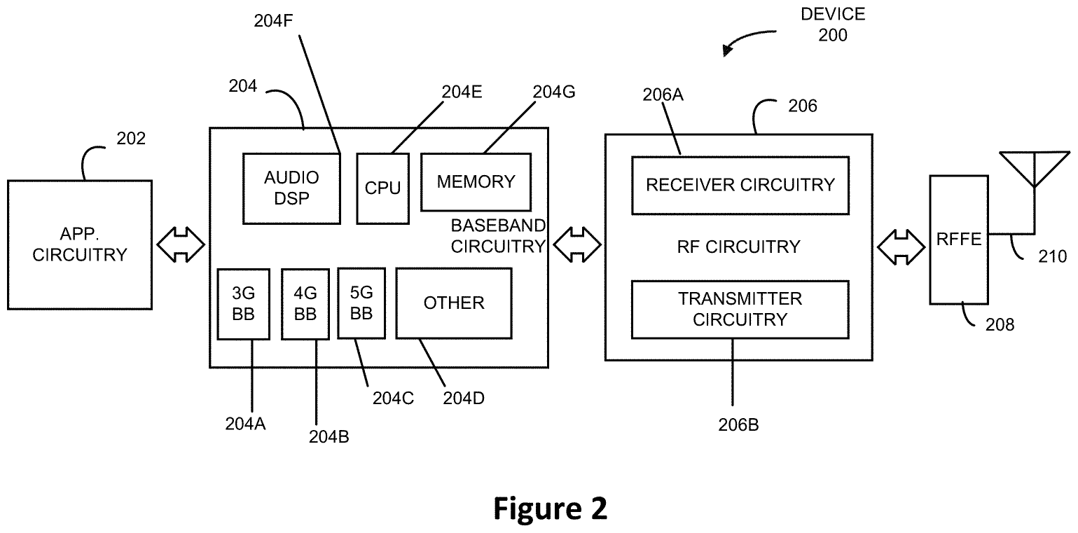

A UE reception may be established by and via the one or more antenna panels 175, RFFE 165, RF circuitry 155, receive circuitry 145, digital baseband circuitry 125, and protocol processing circuitry 115. The one or more antenna panels 175 may receive a transmission from the AN 110 by receive-beamforming signals received by a plurality of antennas/antenna elements of the one or more antenna panels 175. Further details regarding the UE 105 architecture are illustrated in FIGS. 2 and 7-8. The transmission from the AN 110 may be transmit-beamformed by antennas of the AN 110. In some embodiments, the baseband circuitry 125 may contain both the transmit circuitry 135 and the receive circuitry 145. In other embodiments, the baseband circuitry 125 may be implemented in separate chips or modules, for example, one chip including the transmit circuitry 135 and another chip including the receive circuitry 145.

Similar to the UE 105, the AN 110 may include mmWave/sub-mmWave communication circuitry grouped according to functions. The AN 110 may include protocol processing circuitry 120, digital baseband circuitry 130 (or simply, “baseband circuitry 130”), transmit circuitry 140, receive circuitry 150, RF circuitry 160, RFFE 170, and one or more antenna panels 180.

A UL and/or DL transmission may be established by and via the protocol processing circuitry 120, digital baseband circuitry 130, transmit circuitry 140, RF circuitry 160, RFFE 170, and one or more antenna panels 180. The one or more antenna panels 180 may transmit a signal by forming a transmit beam and or receive a signal by forming a receiving beam.

FIG. 2 illustrates example components of a device 200 in accordance with some embodiments. In contrast to FIG. 1, FIG. 2 illustrates example components of the UE 105 or the AN 110 from a receiving and/or transmitting function point of view, and it may not include all of the components described in FIG. 1. In some embodiments, the device 200 may include application circuitry 202, baseband circuitry 204, RF circuitry 206, RFFE circuitry 208, and a plurality of antennas 210 together at least as shown. The baseband circuitry 204 may be similar to and substantially interchangeable with the baseband circuitry 125 in some embodiments. The plurality of antennas 210 may constitute one or more antenna panels for beamforming. The components of the illustrated device 200 may be included in a UE or an AN. In some embodiments, the device 200 may include fewer elements (for example, a cell may not utilize the application circuitry 202, and instead include a processor/controller to process IP data received from an EPC). In some embodiments, the device 200 may include additional elements such as, for example, a memory/storage, display, camera, sensor, or input/output (I/O) interface. In other embodiments, the components described below may be included in more than one device (for example, said circuitry may be separately included in more than one device for Cloud-RAN (C-RAN) implementations).

The application circuitry 202 may include one or more application processors. For example, the application circuitry 202 may include circuitry such as, but not limited to, one or more single-core or multi-core processors. The processor(s) may include any combination of general-purpose processors and dedicated processors (for example, graphics processors, application processors, etc.). The processors may be coupled with or may include memory/storage and may be configured to execute instructions stored in the memory/storage to enable various applications or operating systems to run on the device 200. In some embodiments, processors of application circuitry 202 may process IP data packets received from an EPC.

The baseband circuitry 204 may include circuitry such as, but not limited to, one or more single-core or multi-core processors. The baseband circuitry 204 may be similar to and substantially interchangeable with the baseband circuitry 125 and the baseband circuitry 130 in some embodiments. The baseband circuitry 204 may include one or more baseband processors or control logic to process baseband signals received from a receive signal path of the RF circuitry 206 and to generate baseband signals for a transmit signal path of the RF circuitry 206. Baseband circuitry 204 may interface with the application circuitry 202 for generation and processing of the baseband signals and for controlling operations of the RF circuitry 206. For example, in some embodiments, the baseband circuitry 204 may include a third generation (3G) baseband processor 204A, a fourth generation (4G) baseband processor 204B, a fifth generation (5G) baseband processor 204C, or other baseband processor(s) 204D for other existing generations, generations in development or to be developed in the future (for example, second generation (2G), sixth generation (6G), etc.). The baseband circuitry 204 (for example, one or more of baseband processors 204A-D) may handle various radio control functions that enable communication with one or more radio networks via the RF circuitry 206. In other embodiments, some or all of the functionality of baseband processors 204A-D may be included in modules stored in the memory 204G and executed via a central processing unit (CPU) 204E. The radio control functions may include, but are not limited to, signal modulation/demodulation, encoding/decoding, radio frequency shifting, etc. In some embodiments, modulation/demodulation circuitry of the baseband circuitry 204 may include Fast-Fourier Transform (FFT), precoding, or constellation mapping/demapping functionality. In some embodiments, encoding/decoding circuitry of the baseband circuitry 204 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 204 may include one or more audio digital signal processor(s) (DSP) 204F. The audio DSP(s) 204F may include elements for compression/decompression and echo cancellation and may include other suitable processing elements in other embodiments. Components of the baseband circuitry may be suitably combined in a single chip, in a single chipset, or disposed on a same circuit board in some embodiments. In some embodiments, some or all of the constituent components of the baseband circuitry 204 and the application circuitry 202 may be implemented together such as, for example, on a SOC.

In some embodiments, the baseband circuitry 204 may provide for communication compatible with one or more radio technologies. For example, in some embodiments, the baseband circuitry 204 may support communication with an evolved universal terrestrial radio access network (E-UTRAN) or other wireless metropolitan area networks (WMAN), a wireless local area network (WLAN), a wireless personal area network (WPAN), an NR network, an NR-U network. Embodiments in which the baseband circuitry 204 is configured to support radio communications of more than one wireless protocol may be referred to as multi-mode baseband circuitry.

RF circuitry 206 may enable communication with wireless networks using modulated electromagnetic radiation through a non-solid medium. In various embodiments, the RF circuitry 206 may include one or more switches, filters, amplifiers, etc. to facilitate the communication with the wireless network. RF circuitry 206 may include receiver circuitry 206A, which may include circuitry to down-convert RF signals received from the RFFE circuitry 208 and provide baseband signals to the baseband circuitry 204. RF circuitry 206 may also include transmitter circuitry 206B, which may include circuitry to up-convert baseband signals provided by the baseband circuitry 204 and provide RF output signals to the RFFE circuitry 208 for transmission.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 206 may include analog-to-digital converter (ADC) and digital-to-analog converter (DAC) circuitry and the baseband circuitry 204 may include a digital baseband interface to communicate with the RF circuitry 206.

In some dual-mode embodiments, a separate radio integrated circuit (IC) circuitry may be provided for processing signals for each spectrum, although the scope of the embodiments is not limited in this respect.

RFFE circuitry 208 may include a receive signal path, which may include circuitry configured to operate on RF beams received from one or more antennas 210. The RF beams may be transmit beams formed and transmitted by the AN 110 while operating in mmWave or sub-mmWave frequency rang. The RFFE circuitry 208 coupled with the one or more antennas 210 may receive the transmit beams and proceed them to the RF circuitry 206 for further processing. RFFE circuitry 208 may also include a transmit signal path, which may include circuitry configured to amplify signals for transmission provided by the RF circuitry 206 for transmission by one or more of the antennas 210, with or without beamforming. In various embodiments, the amplification through transmit or receive signal paths may be done solely in the RF circuitry 206, solely in the RFFE circuitry 208, or in both the RF circuitry 206 and the RFFE circuitry 208.

In some embodiments, the RFFE circuitry 208 may include a TX/RX switch to switch between transmit mode and receive mode operation. The RFFE circuitry 208 may include a receive signal path and a transmit signal path. The receive signal path of the RFFE circuitry 208 may include a low noise amplifier (LNA) to amplify received RF beams and provide the amplified received RF signals as an output (for example, to the RF circuitry 206). The transmit signal path of the RFFE circuitry 208 may include a power amplifier (PA) to amplify input RF signals (for example, provided by RF circuitry 206), and one or more filters to generate RF signals for beamforming and subsequent transmission (for example, by one or more of the one or more antennas 210).

Processors of the application circuitry 202 and processors of the baseband circuitry 204 may be used to execute elements of one or more instances of a protocol stack. For example, processors of the baseband circuitry 204, alone or in combination, may be used to execute Layer 3, Layer 2, or Layer 1 functionality, while processors of the application circuitry 202 may utilize data (for example, packet data) received from these layers and further execute Layer 4 functionality (for example, transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/AN, described in further detail below.

NR may be aimed to be a unified network and/or system that serves different, sometimes conflicting, performance dimensions and services. NR may evolve with new radio access technologies (RATs) and aim to provide seamless wireless connectivity solutions among multiple access technologies.

Conventionally, a four-step procedure may be used for contention-based or contention-free random access in NR communications. In the contention-based random access four-step procedure, a UE 105 may transmit PRACH in an uplink by randomly selecting one preamble signature, which may allow an AN 110 to estimate the delay between the UE 105 and the AN 110 for subsequent uplink timing adjustment, in the first step of the procedure. In the second step of the procedure, the AN 110 may generate feedback of a RAR, which may carry TA command information and/or an uplink grant for an uplink transmission in the third step of the procedure. A two-step RACH procedure may be beneficial in reducing or aiming to reduce access latency introduced in the four-step RACH procedure.

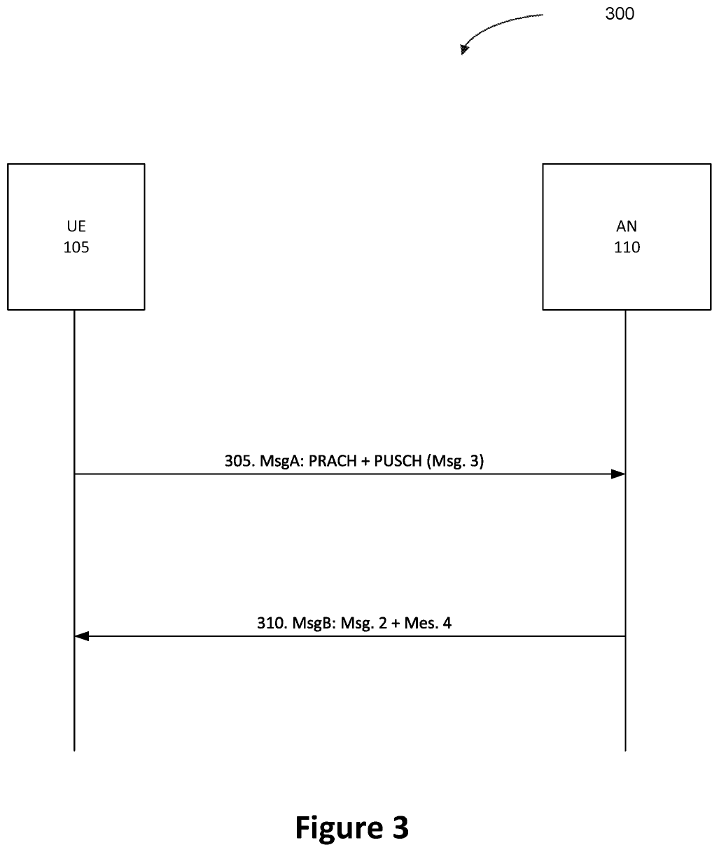

FIG. 3 illustrates a two-step RACH procedure 300, in accordance with various embodiments. In this two-step RACH procedure, the UE 105 may transmit a first message (e.g., a MsgA 305) that may include a PRACH/PRACH preamble and PUSCH. Such a PUSCH may be the same as or substantially similar to a Msg3 in the four-step RACH procedure. Upon processing the MsgA, the AN 110 may generate a MsgB 310 as a response to the UE 105. The MsgB 310 may include information of, or function as, Msg2 and Msg4 in the four-step RACH procedure. In various embodiments, mapping rules and/or associations between the transmission of PRACH and the MsgA PUSCH in the MsgA 305 may be illustrated comparing the two-step RACH procedure to the four-step RACH procedure. Further, corresponding DMRS configuration for MsgA PUSCH transmission is illustrated.

### Association/Mapping Between PRACH and MsgA PUSCH

In embodiments according to the two-step RACH procedure, the first step may involve one or more mapping or association rules with respect to the transmission of PRACH or PRACH preamble and the MsgA PUSCH. According to those rules, upon reception of the MsgA 305, the AN 110 may detect the PRACH first, then decode the MsgA PUSCH.

One of those rules may define a MsgA PUSCH resource set or pool, which may include one or more MsgA PUSCH resources. Meanwhile, one or more PRACH resources may be partitioned into multiple PRACH resource subsets, each of which may include one or more PRACH occasions and/or one or more PRACH sequences within one PRACH occasion.

Further, one or more parameters may be configured with respect to, or associated with, each MsgA PUSCH resource. These parameters may include, but are not limited, to:
a MsgA PUSCH resource identification (ID);
time and frequency domain resource allocation;
modulation and coding scheme (MCS);
power control related parameters;
DMRS related configurations;
one or more PRACH resource subsets which are associated with this MsgA PUSCH resource ID; and
one or more indications regarding whether uplink control information can be multiplexed on the MsgA PUSCH. Note that if this indication is on or positive, beta offset and/or scaling factor may be configured to allow the UE 105 to determine the amount of resources for UCI on the MsgA PUSCH.

In addition, the MCS may be selected from a predefined or configured table based on some modulation orders. For example, in one or more scenarios, only QPSK-based MCS may be selected. Note that the one or more parameters may be configured by higher layers via NR remaining minimum system information (RMSI), NR other system information (OSI), and/or dedicated radio resource control (RRC) signaling.

In some embodiments, an explicit association or mapping between one or more PRACH resource subsets and an MsgA PUSCH resource may be signaled. For example, a PRACH resource subset may be indicated as a PRACH occasion index and/or one or more PRACH preamble sequences within the PRACH occasion. Further, MsgA PUSCH resource may include time and/or frequency resource, and DMRS antenna port (AP) of MsgA PUSCH.

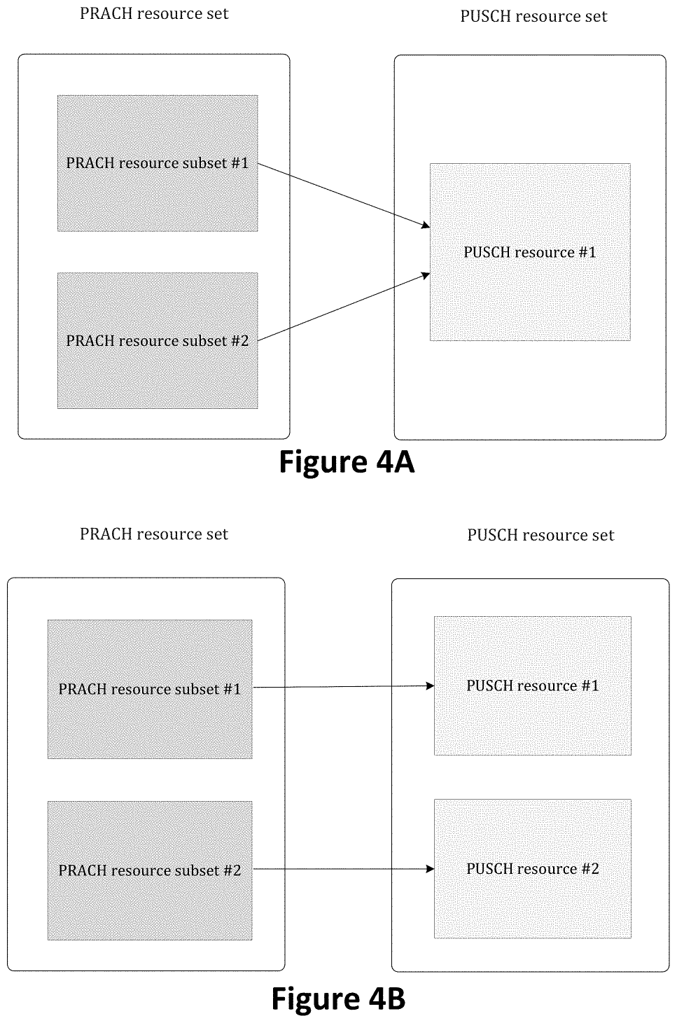

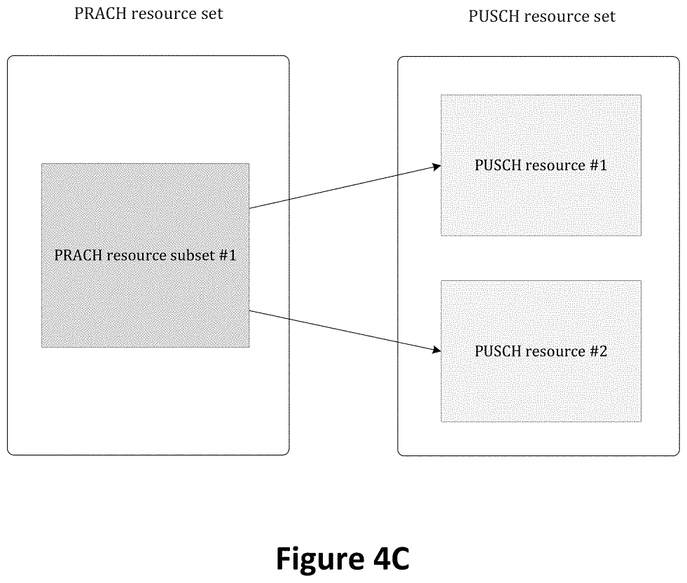

FIGS. 4A-4C illustrate some example associations/mappings between PRACH resource subset(s) and MsgA PUSCH resource(s), in accordance with various embodiments. In various embodiments, the association or mapping between one or more PRACH resource subsets and one or more MsgA PUSCH resources may hold various mapping relationships. For example, the association between the PRACH resource subset(s) and the MsgA PUSCH resource(s) may be a many-to-one as shown in FIG. 4A, one-to-one as shown in FIG. 4B, or one-to-many association as shown in FIG. 4C. A many-to-one association may refer to that more than one PRACH resource subset are associated with one MsgA PUSCH resource. A one-to-one association may refer to that one PRACH resource subset is associated with one MsgA PUSCH resource. A one-to-many association may refer to that one PRACH resource subset is associated with more than one MsgA PUSCH resource.

The above-mentioned three association/mapping relationships may be used based on specific AN configuration and/or implementations. For example, if an advanced receiver is implemented at the AN 110 and the two-step RACH procedure is used for scheduling a request when corresponding uplink synchronization is already achieved from the UE 105, a MsgA PUSCH resource may be associated with more than one PRACH resource subsets. In this example, when multiple UEs transmit one or more PRACH preambles using different preambles and corresponding MsgA PUSCHs are used with a shared time and/or frequency resource, the AN 110 may detect more than one PRACH preamble and subsequently decode more than one MsgA PUSCHs using the advanced receiver. For example, the advanced receiver may be an interference cancellation-based receiver, or other like receiver.

In some embodiments, one or more MsgA PUSCH resources may be associated with one or more PRACH occasions. The one or more PRACH occasions may be associated with one synchronization signal block (SSB). The number of PRACH occasions per MsgA PUSCH resource may be determined and/or configured by higher layers via RMSI. A value may be used to indicate the number of PRACH occasions per MsgA PUSCH resource. For example, the value may be smaller than one, which may indicate that more than one PRACH occasions are associated with one MsgA PUSCH resource. A value greater than one may indicate that more than one MsgA PUSCH resources are associated with one PRACH occasion. In some other examples, a value smaller than one may indicate that more than one MsgA PUSCH resources are associated with one PRACH occasion and a value greater than one may indicate that more than one PRACH occasions are associated with one MsgA PUSCH resource. Meanwhile, a value of one may indicate that one MsgA PUSCH resource is associated with one PRACH occasion.

In some embodiments, within one PRACH occasion, a range of a PRACH preamble index that is associated with one MsgA PUSCH resource may be explicitly configured or implicitly derived according to the preamble index configured for the four-step RACH procedure. For example, if eight preamble indexes are allocated for the two-step RACH procedure and the preamble indexes that are configured for the four-step RACH procedure are from 0 to 15, the preamble indexes for the two-step procedure may be from 16 to 23.

In some embodiments, one or more implicit association rules between the PRACH resource subsets and the MsgA PUSCH may be used. For example, if it is assumed that the number of PRACH resource subsets for MsgA is M and the number of MsgA PUSCH resources is N, the association rule(s) may be defined as:
if M>N, PRACH resource subset m may be associated with MsgA PUSCH resource in a relationship that n=(m mod N), which indicates a remainder after m is divided by N;
if M=N, PRACH resource subset m may be associated with MsgA PUSCH resource in a relationship that n=m;
if M<N, PRACH resource subset m may be associated with MsgA PUSCH resource in a relationship that m=(n mod M), which indicates a remainder after n is divided by M,
   where m=0, 1 . . . M−1 and n=0, 1 . . . N−1.

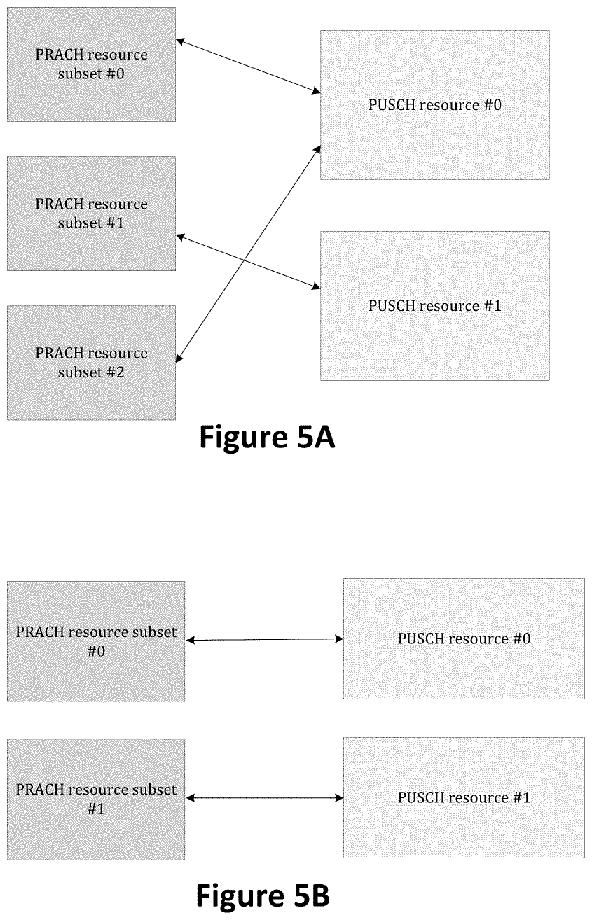

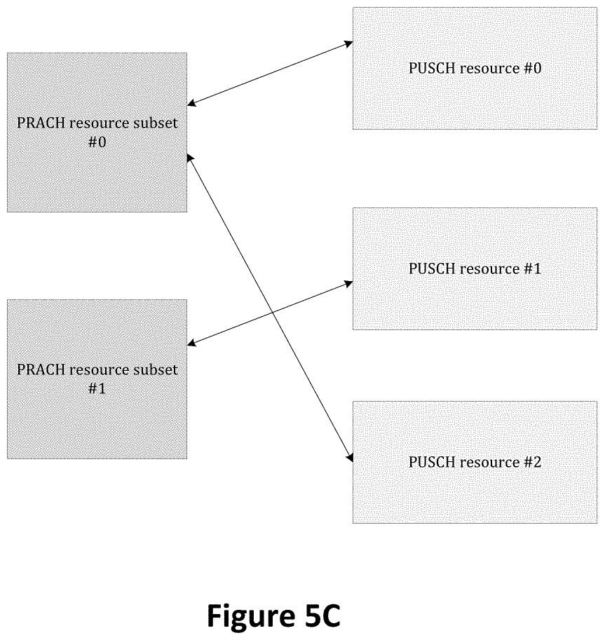

FIGS. 5A-5C illustrate some example associations between PRACH resource subset(s) and MsgA PUSCH resource(s) based on the above M and N relationship, in accordance with various embodiments.

FIG. 5A illustrates an example of M=3 and N=2. In this example, PRACH resource subsets #0 and #2 may be associated with MsgA PUSCH resource #0, and PRACH resource subset #1 may be associated with MsgA PUSCH resource #1.

FIG. 5B illustrates an example of M=N=2. In this example, PRACH resource subset #0 may be associated with MsgA PUSCH resource #0, and PRACH resource subset #1 may be associated with MsgA resource #1.

FIG. 5C illustrates an example of M=2 and N=3. In this example, PRACH resource subset #0 may be associated with MsgA PUSCH resources #0 and #2, and PRACH resource subset #1 may be associated with MsgA resource #1.

In embodiments, one or more MsgA PUSCH resource sets or pools may be used and a MsgA PUSCH resource set or pool may include one or more MsgA PUSCH resources. One or more MsgA PUSCH resources may be configured with one or more offsets and/or periodicities. Note that the term “MsgA PUSCH resource set” and term “MsgA PUSCH resource pool’ may be used interchangeably throughout this disclosure.

Further, one or more subsets of PRACH occasions may be associated with MsgA PUSCH resources, which may be used to reduce some overhead of MsgA PUSCH and/or improve system-level spectrum efficiency.

In one example, a longer periodicity of a MsgA PUSCH resource may be configured compared with that of PRACH occasions and/or an association period between an SSB and PRACH occasions. Note that this may be defined as an association period between the MsgA PUSCH resource and PRACH occasions. Further, within such a periodicity, a bitmap and/or one or more numbers of the MsgA PUSCH occasions may be configured to associate a MsgA transmission including both PRACH and MsgA PUSCH with an SSB.

In one example, the periodicity of the MsgA PUSCH resource may be configured as a multiple of periodicity of PRACH occasions or an association between the SSB and PRACH occasions. For instance, if a periodicity of PRACH occasions is 20 milliseconds (ms), the MsgA PUSCH resource may be configured with 20×K ms. In some embodiments, K or another scaling factor between the periodicity of MsgA PUSCH resource and PRACH occasions may be configured via RMSI and/or dedicated RRC signaling. K may be a positive integer or in other similar forms. In one example, K may be equal to 2ⁿ and n may be a positive integer. In another example, the periodicity of MsgA PUSCH resource may be directly configured as a part of MsgA PUSCH resource configuration.

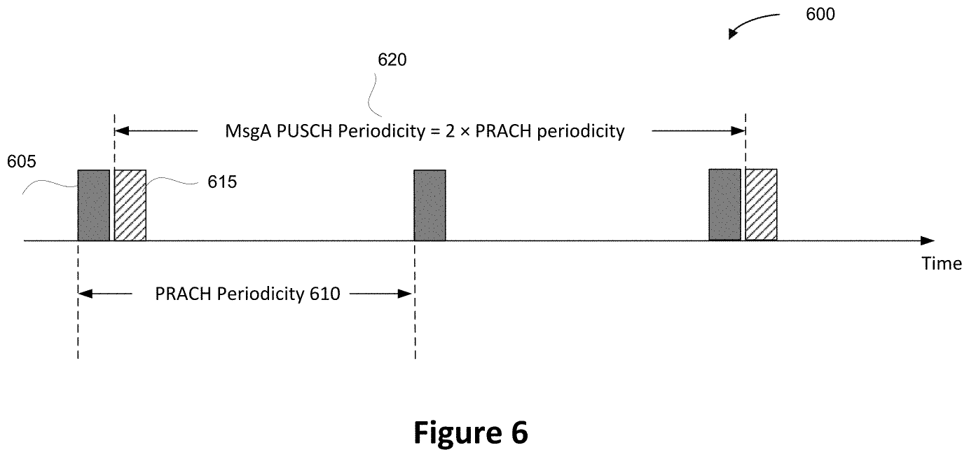

FIG. 6 illustrates an example of MsgA PUSCH resource periodicity, in accordance with various embodiments. A PRACH occasion(s) 605 may have a PRACH periodicity 610. The PRACH periodicity 610 may be referred to as the association period. A MsgA PUSCH resource(s) 615 may have a MsgA PUSCH periodicity 620. The MsgA PUSCH periodicity 620 may be two times of the PRACH periodicity 610. Thus, only one or more subsets of PRACH occasions may be associated with a MsgA PUSCH resource.

In some embodiments, a bitmap may be configured to indicate a subset of PRACH occasions in the two-step RACH procedure. For example, a bit of “1” in the bitmap may indicate that the PRACH occasion(s) is associated with the MsgA PUSCH resource, while a bit “0” may indicate that the PRACH occasion(s) is not associated with the MsgA PUSCH resource, or vice versa. This bitmap may allow the subset(s) of PRACH occasions to be associated with the MsgA PUSCH resource(s).

In one example, if four PRACH occasions are configured within one PRACH period or one association period, a bitmap “1010” may indicate that PRACH occasions #0 and #2 are associated with MsgA PUSCH resource and PRACH occasions #1 and #3 are not associated with MsgA PUSCH resource.

In some embodiments, a PRACH occasion(s) and MsgA PUSCH resource(s) may be associated with an implicit association. For example, upon configuration of a slot offset relative to frame boundary and a periodicity of MsgA PUSCH resource, the UE 105 may determine the implicit association in accordance with a distance between a PRACH occasion and MsgA PUSCH. Such a distance may be measured in time or other relative references. For example, a MsgA PUSCH resource may be associated with one or more PRACH resources with a slot offset that is configured by higher layer. Such a distance may be in time domain as illustrated in FIG. 6. Additionally or alternatively, such a distance may be measured in other domains in accordance with various embodiments. Note that one PRACH slot may include one or more PRACH occasions.

In addition, if more than one PRACH occasion is defined within one slot, more than one MsgA PUSCH resources may be multiplexed in a time division modulation (TDM) manner in a slot or more than one slot, which may be associated with one PRACH occasion in one slot.

In embodiments, various power-control related parameters may be defined for different MsgA PUSCH resources. Those power-control related parameters may include, but are not limited to, path loss thresholds and configured power offsets. For example, the UE 105 may determine a MsgA PUSCH resource in accordance with configured MCS and/or path loss thresholds. Then, the UE 105 may transmit corresponding PRACH preamble in accordance with the associated MsgA PUSCH resource. If more than one PRACH preambles are included in association with PRACH resource, the UE may randomly select one PRACH preamble for corresponding MsgA transmission in a contention-based two-step RACH procedure.

In one example, if

Pathloss=P_{c,max}−P_{target,PRACH}−ΔM_{sgA,PRACH}−Δ_{offset}

where P_{c,max} is the maximum transmission power with the assumption of x dB. For example, x may be zero and there is no power reduction, P_{target,PRACH} is the target PRACH received power, Δ_{MsgA,PRACH} is the configured power offset between MsgA PUSCH and associated PRACH, and Δ_{offset} is the configured power offset for different MsgA PUSCH resources. Note that Δ_{MsgA,PRACH}+Δ_{offset} may be combined and signaled as a single parameter for each MsgA PUSCH resource. In such a scenario, a path loss threshold(s) may be used to determine which MsgA PUSCH resource and/or associated PRACH preamble are to be used for the MsgA transmission. For example,

$$\{ \begin{matrix}{Pathloss}_{thres , 0} < Pathloss & MsgA PUSCH resource 0 \\ {Pathloss}_{thres , 1} < Pathloss \leq {Pathloss}_{thres , 0} & MsgA PUSCH resource 1 \\ … & … \\ Pathloss < {Pathloss}_{thres , K - 1} & MsgA PUSCH resource K - 1\end{matrix}$$

In another example, the MsgA PUSCH resource selection or determination may be based on measured higher layer filtered reference signal received power (RSRP) and/or layer 1 RSRP. In this regard, one or more RSRP thresholds may be configured or pre-defined for MsgA PUSCH resource selection or determination. For example,

$$\{ \begin{matrix}{RSRP}_{thres , 0} < RSRP & MsgA PUSCH resource 0 \\ {RSRP}_{thres , 1} < RSRP \leq {RSRP}_{thres , 0} & MsgA PUSCH resource 1 \\ … & … \\ RSRP < {RSRP}_{thres , K - 1} & MsgA PUSCH resource K - 1\end{matrix}$$

In addition, the UE 105 may skip or not select the PUSCH resource(s) whose supported transport block size is smaller than corresponding MsgA payload size.

In some embodiments, various power-control related parameters may be defined for different PRACH resources. Those power-control related parameters may include, but are not limited to, path loss thresholds and configured power offsets. For example, the UE 105 may determine a PRACH resource in accordance with path loss thresholds. Then, the UE 105 may transmit corresponding MsgA PUSCH resource(s) in accordance with the associated PRACH preamble. If more than one PRACH preamble are included in the PRACH resource, the UE may randomly select one PRACH preamble for corresponding MsgA transmission in a contention-based two-step RACH procedure.

In one example, if

Pathloss=P_{c,max}−P_{target,PRACH}−Δ_{MsgA,PRACH}−Δ_{offset}

The path loss thresholds may be used to determine which PRACH resource(s) and/or associated MsgA PUSCH are to be used for the MsgA transmission. For example,

$$\{ \begin{matrix}{Pathloss}_{thres , 0} < Pathloss & PRACH resource 0 \\ {Pathloss}_{thres , 1} < Pathloss \leq {Pathloss}_{thres , 0} & PRACH resource 1 \\ … & … \\ Pathloss < {Pathloss}_{thres , K - 1} & PRACH resource K - 1\end{matrix}$$

In another example, the PRACH resource selection or determination may be based on measured higher layer filtered reference signal received power (RSRP) and/or layer 1 RSRP. In this regard, one or more RSRP thresholds may be configured or pre-defined for MsgA PUSCH resource selection or determination. For example,

$$\{ \begin{matrix}{RSRP}_{thres , 0} < RSRP & PRACH resource 0 \\ {RSRP}_{thres , 1} < RSRP \leq {RSRP}_{thres , 0} & PRACH resource 1 \\ … & … \\ RSRP < {RSRP}_{thres , K - 1} & PRACH resource K - 1\end{matrix}$$

In addition, the UE 105 may skip or not select the PUSCH resource(s) whose supported transport block size is smaller than corresponding MsgA payload size.

### DMRS Configuration

The contention-based two-step RACH procedure may be used for scheduling request. In this procedure, the MsgA PUSCH may carry buffer status report (BSR) information for uplink data packets. Under the condition that corresponding uplink synchronization may be achieved, the same MsgA PUSCH resource may be allocated for multiple UEs to increase overall capacity of the MsgA in the two-step RACH procedure, if one or more advanced receivers are to be employed by the AN 110. Thus, more than one DMRS antenna ports (APs) may be defined for the MsgA PUSCH transmission, which may allow the AN 110 to estimate respective channels from different UEs when more than one UE transmit the MsgA PUSCH in or with one or more shared physical resources.

In some embodiments, more than one DMRS AP may be used or defined for the MsgA PUSCH transmission for cyclic-prefix orthogonal frequency division multiplexing (CP-OFDM) and/or discrete Fourier transform-spread-OFDM (DFT-s-OFDM) waveforms. To reduce potential collision among DMRS APs and/or improve channel estimation performance, DMRS AP may be defined as a function of one or more parameters. Those parameters may include, but are not limited to, random access radio network temporary identifier (RA-RNTI) for the associated PRACH transmission, PRACH preamble index, and PRACH occasion index.

In some embodiments, upon successfully detecting the PRACH preamble, the AN 110 may derive the DMRS APs. Thu AN 100 may subsequently estimate the channel and decode the MsgA PUSCH.

In one example, the DMRS AP may be determined based on this equation:

I_{DMRS}^{AP}=mod(I_{preamble},N_{DMRS}^{AP})

Where I_{preamble} is the preamble index, N_{AP}^{DMRS} is the total number of DMRS APs for one PUSCH occasion, which may be predefined in the specification or configured by higher layers. Note that this may apply for the case when one PRACH occasion is associated with one PUSCH occasion. When more than one PRACH occasion are associated with a single PUSCH occasion, one or more groups of PRACH preamble indexes within one PRACH occasion may be associated with one subset of DMRS APs for PUSCH transmission. Assuming N_{RO} PRACH occasions are associated with one PUSCH occasion, then the number of DMRS APs associated with a subset of PRACH preambles within one PRACH occasion can be given as

$$\frac{{N}_{DMRS}^{AP}}{{N}_{RO}} .$$

Further, the DMRS AP can be derived as

$${I}_{DMRS}^{AP} = mod ( {I}_{preamble} , \frac{{N}_{DMRS}^{AP}}{{N}_{RO}} ) + i \cdot \frac{{N}_{DMRS}^{AP}}{{N}_{RO}} , i = 0 , 1 , … , {N}_{RO} - 1 ,$$

For example, if two PRACH occasions are associated with one PUSCH occasion and a total number of DMRS APs for one PUSCH occasion is 12, a number of DMRS APs associated with one PRACH occasion may be 6. Note that a subset of PRACH preambles in one PRACH occasion may be configured as {45, 46, . . . , 63}. Thus, the PRACH preamble index {45, 46, . . . , 63} in 1^{st} PRACH occasion may be mapped to DMRS AP from {0, . . . , 5} and the PRACH preamble index {45, 46, . . . , 63} in 2^{nd} PRACH occasion may be mapped to DMRS AP from {6, . . . , 11}.

In another example, if one PRACH occasion is associated with more than one PUSCH occasions, the number of PRACH preamble sequences associated with one PUSCH occasion may be equally divided from the configured number of preamble sequences. Assuming N_{Pramble} preamble indexes are configured for 2-step RACH in one PRACH occasion, and one PRACH occasion is associated with N_{PO} PUSCH occasions, then the number of preamble indexes associated with one PUSCH occasion is

$$\frac{{N}_{Pramble}}{{N}_{PO}} .$$

Similar to the case with one-to-one

I_{DMRS}^{AP}=mod(I_{preamble},N_{DMRS}^{AP})

In some embodiments, a new parameter rachOccasion-perPUSCHOccasion may be configured by higher layers to indicate how many PRACH occasions are associated with PUSCH occasions. For instance, when the value of this parameter, N_{RO}^{PO} is less than 1, e.g., ½, ¼, one PRACH occasion may be associated with

$$\frac{1}{{N}_{RO}^{PO}}$$

PUSCH occasions. When the value of this parameter, N_{RO}^{PO} may be equal to 1, one PRACH occasion is associated with one PUSCH occasions. When the value of this parameter, N_{RO}^{PO} is great than 1, e.g., 2, 4, 8, N_{RO}^{PO} PRACH occasion may be associated with one PUSCH occasions.

In some embodiments, DMRS AP may be explicitly configured by higher layers via dedicated RRC signaling. This may be applied for contention-free two-step RACH procedure. This may also be configured as part of MsgA PUSCH resource configuration.

In some embodiments, with respect to CP-OFDM based waveform, initialization seed for DMRS sequence generation may be defined as a function of one or more following parameters: RA-RNTI, PRACH preamble index, PRACH occasion index, etc. This may also be applied to DFT-s-OFDM waveform when pi/2 BPSK based DMRS is used.

In one example, PRACH preamble may be divided into two groups. Each divided group may be associated with n_{SCID}, e.g., n_{SCID}=I_{PRACH} mod 2 for the initialization of DMRS sequence generation for MsgA PUSCH with CP-OFDM waveform. Further, the PRACH preamble group partition may be predefined or configured to the UE 105 by higher layer signaling. In such an example, two scrambling identifications (IDs), which may be scarmblingID0 and scarmblingID1, may be configured by higher layers via MSI, RMSI, OSI, or RRC signaling.

Further, the PRACH preamble may be divided into N groups. N may be an integer that is equal to or greater than 2. N may be fixed or constant that is specified or predetermined or configured by higher layers via MSI, RMSI, OSI, or RRC signaling. Each PRACH group may be associated with one n_{SCID}, and n_{SCID}=I_{PRACH} mod N Note that the range of n_{SCID} here may be extended to {0, 1, “ . . . ”, N−1}. Further, N scrambling IDs may be configured by higher layers via MSI, RMSI, OSI, or RRC signaling. In addition, RA-RNTI in the two-step RACH procedure may be different from the RA-RNTI in the two-step RACH procedure.

In some embodiments, a DMRS sequence generation may be initialized as

cᵢₙᵢₜ=(2¹⁷(N_{symb}^{slot}n_{s,f}^{μ}+l+1)(2N_{ID}ⁿ^{_{SCID}}+1)+2N_{ID}ⁿ^{_{SCID}}+n_{SCID})mod 2³¹

In the DMRS sequence generation for MsgA PUSCH for the two-step RACH procedure, RA-RNTI and preamble index may be included in the initialization seed for DMRS sequence generation. For example, n_{SCID} may be set to 0 and n_{SCID} may be expressed by

N_{ID}ⁿ^{_{SCID}}=c₀·RA-RNTI+c₁·I_{preamble},

where c₀, c₁ may be constants and/or predetermined. For example, c₀=c₁=1.

In an Option 1, N scrambling IDs may be configured in a cell specific manner or configured per MsgA PUSCH configuration. In an example, with respect to the association between preamble and PUSCH resource unit (PRU), DMRS index may be ordered by DMRS AP first, then followed by DMRS sequence index. The DMRS sequence index may be indicated by n_{SCID}. The DMRS AP index and DMRS sequence index may be derived as

n_{AP}=(n_{PRU}) mod (N_{AP})

n_{SCID}=└n_{PRU}/N_{AP}┐

Where n_{PRU} is the PRU index for each PUSCH occasion; n_{AP} is the DMRS AP index; n_{SCID} is the DMRS sequence index; and N_{AP} is the number of DMRS AP, which is configured for a MsgA PUSCH configuration or in a cell specific manner. Table 1 illustrates one example of DMRS index ordering for DMRS AP and sequence index in accordance with Option 1. In this example, eight PRUs may be configured in one PUSCH occasion with two DMRS APs and four DMRS sequences. Thus, the DMRS AP index may be {0, 1, 0, 1, 0, 1, 0, 1} and the sequence index may be {0, 0, 1, 1, 2, 2, 3, 3}.

TABLE 1
DMRS index ordering for DMRS AP and sequence index Option 1

PRU#7 (n_AP = 1, n_SCID = 3)
PRU#6 (n_AP = 0, n_SCID = 3)
PRU#5 (n_AP = 1, n_SCID = 2)
PRU#4 (n_AP = 0, n_SCID = 2)
PRU#3 (n_AP = 1, n_SCID = 1)
PRU#2 (n_AP = 0, n_SCID = 1)
PRU#1 (n_AP = 1, n_SCID = 0)
PRU#0 (n_AP = 0, n_SCID = 0)

In Option 2, with respect to the association between preamble and PRU, DMRS index may be ordered by DMRS sequence index first, then followed by DMRS AP. The DMRS sequence index may be indicated by n_{SCID}. The DMRS AP index and DMRS sequence index may be derived as

n_{AP}=└n_{PRU}/N_{SCID}┐

n_{SCID}=(n_{PRU}) mod (N_{SCID})

Where n_{SCID} is the number of DMRS sequences, and may be configured in a MsgA PUSCH configuration or in a cell specific manner. Table 2 illustrates an example of DMRS index ordering for DMRS AP and sequence index in accordance with Option 2. In this example, eight PRUs may be configured in a PUSCH occasion with two DMRS APs and four DMRS sequences. Thus, the DMRS AP index may be {0, 0, 0, 0, 1, 1, 1, 1} and the sequence index may be {0, 1, 2, 3, 0, 1, 2, 3}.

TABLE 2
DMRS index ordering for DMRS AP and sequence index Option 2

PRU#7 (n_AP = 1, n_SCID = 3)
PRU#6 (n_AP = 1, n_SCID = 2)
PRU#5 (n_AP = 1, n_SCID = 1)
PRU#4 (n_AP = 1, n_SCID = 0)
PRU#3 (n_AP = 0, n_SCID = 3)
PRU#2 (n_AP = 0, n_SCID = 2)
PRU#1 (n_AP = 0, n_SCID = 1)
PRU#0 (n_AP = 0, n_SCID = 0)

In some embodiments, with respect to DFT-S-OFDM based waveform, a configuration parameter a may be defined as a function of one or more parameters, which may include, but are limited to, RA-RNTI, PRACH preamble index, and PRACH occasion index.

In one example, a combination of PRACH preamble index and RACH occasion index may be divided into eight groups. Each group may be associated with an α of a unique value. The value of α may be determined based on below equation:

$$α = \frac{( {I}_{PRACH} + {I}_{RO} ) mod 8}{8}$$

In some embodiments, with respect to DFT-s-OFDM waveform, only one DMRS may be defined. In some other embodiments, with respect to DFT-s-OFDM waveform, RA-RNTI and preamble index may be divided into N groups. N may be predetermined or configured by higher layers via MSI, RMSI, OSI, or RRC signaling. Each PRACH group may be associated with one n_{ID}^{RS(i)}, i=0, 1, . . . , N−1

i=(RA-RNTI+I_{PRACH})mod N

Where n_{ID}^{RS(i)} may be configured by higher layers via MSI, RMSI, OSI or RRC signaling. Further, RA-RNTI in the two-step RACH procedure may be different from the RA-RNTI in the two-step RACH procedure.

In some other embodiments, n_{ID}^{RS} may be determined or expressed by

n_{ID}^{RS}=c₀·RA-RNTI+c₁·I_{preamble},

where c₀, c₁ may be constants and/or predetermined. For example, c₀=c₁=1.

With respect to DFT-s-OFDM waveform, the same or a substantially similar approach for CP-OFDM waveform may be used for derivation of DMRS AP and DMRS sequence index. For example, N n_{ID}^{RS} may be configured in a cell specific manner or configured per MsgA PUSCH configuration.

In addition, with respect to the association between preamble and PUSCH resource PRU, DMRS index may be ordered by DMRS AP first, then followed by DMRS sequence index. In another example, with respect to the association between preamble and PRU, DMRS index may be ordered by DMRS sequence index first, then followed by DMRS AP.

In some embodiments, a DMRS type, which may be either Type 1 or Type 2, may be configured by an RRC signaling or predetermined. In addition, whether there is additional DMRS in a later part(s) of a slot or a number of DMRS symbols within one slot may be configured by RRC signaling or predefined. In one example, Type 1 DMRS may be used for a MsgA PUSCH transmission. In some other examples, a different DMRS type may be associated with different PUSCH resources or PRACH resources. With respect to DFT-s-OFDM, whether pi/2 BPSK based DMRS can be used may be predefined or configured per PUSCH resource or for some or all PUSCH resources.

In some embodiments, the UE 105 may assume that phase tracking RS (PT-RS) is not transmitted and/or associated with the MsgA PUSCH. Alternatively, the PT-RS may be transmitted and/or associated with the MsgA PUSCH based on one or more patterns. A PT-RS pattern in this regard may be selected based on configured MCS and bandwidth with respect to corresponding PUSCH resource, and/or a predefined threshold.

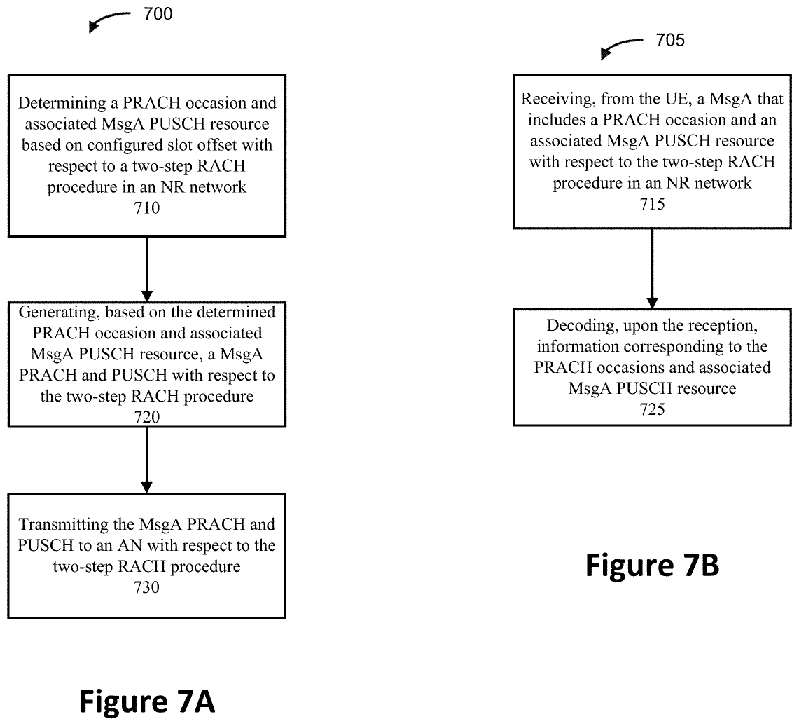

FIG. 7A illustrates an operation flow/algorithmic structure 700 to facilitate a process of generation and transmission of a MsgA with respect to the two-step RACH procedure by the UE 105 in NR involved networks, in accordance with various embodiments. The operation flow/algorithmic structure 700 may be performed by the UE 105 or circuitry thereof.

The operation flow/algorithmic structure 700 may include, at 710, determining one PRACH occasion and one associated PUSCH resource based on a configured slot offset with respect to a two-step RACH procedure in an NR network. Determining the one PUSCH resource may be based on the decoded slot offset and the one PRACH occasion. The PRACH slot may include one or more preambles and the one or more preambles respectively correspond to one or more PUSCH resource units (PRU).

In some embodiments, the UE 105 may decode, upon reception of a configuration message from the AN, a slot offset that indicates a time distance from a boundary of a PRACH occasion and a MsgA PUSCH resource.

In some embodiments, the UE 105 may determine PRACH resources corresponding to the PRACH occasion, based on a path loss with respect to a transmission or reception between the UE and the AN 110. Further, the UE 105 may compare path loss with one or more path loss thresholds to determine the PRACH occasion.

In some embodiments, the UE 105 may determine the PRACH resources corresponding to the PRACH occasion based on one or more RSRPs that are to be compared with one or more RSRP thresholds. The IE 105 may compare the one or more RSRPs with one or more RSRP thresholds. The one or more RSRPs are higher layer filtered RSRPs or layer 1 RSRPs.

The operation flow/algorithmic structure 700 may further include, at 720, generating, based on the determined one PRACH occasion and associated one PUSCH resource, a MsgA PRACH and PUSCH with respect to the two-step RACH procedure.

The operation flow/algorithmic structure 700 may further include, at 730, transmitting the MsgA PRACH and PUSCH to the AN 110 with respect to the two-step RACH procedure.

FIG. 7B illustrates an operation flow/algorithmic structure 705 to facilitate the process of generation and transmission of a MsgA with respect to the two-step RACH procedure by the AN 110 in NR involved networks, in accordance with various embodiments. The operation flow/algorithmic structure 705 may be performed by the AN 110 or circuitry thereof.

The operation flow/algorithmic structure 705 may include, at 715, receiving, from the UE, a MsgA that includes one PRACH occasion and one associated MsgA PUSCH resource with respect to the two-step RACH procedure in an NR network.

The operation flow/algorithmic structure 705 may further include, at 725, decoding, upon the reception, information corresponding to the one PRACH occasion and associated MsgA PUSCH resource.

In some embodiments, the AN 110 may first generate a configuration message that indicates a slot offset that indicates a time distance from a boundary of one or more PRACH occasions and the one or more MsgA PUSCH resources, and transmit the configuration message to the UE 105.

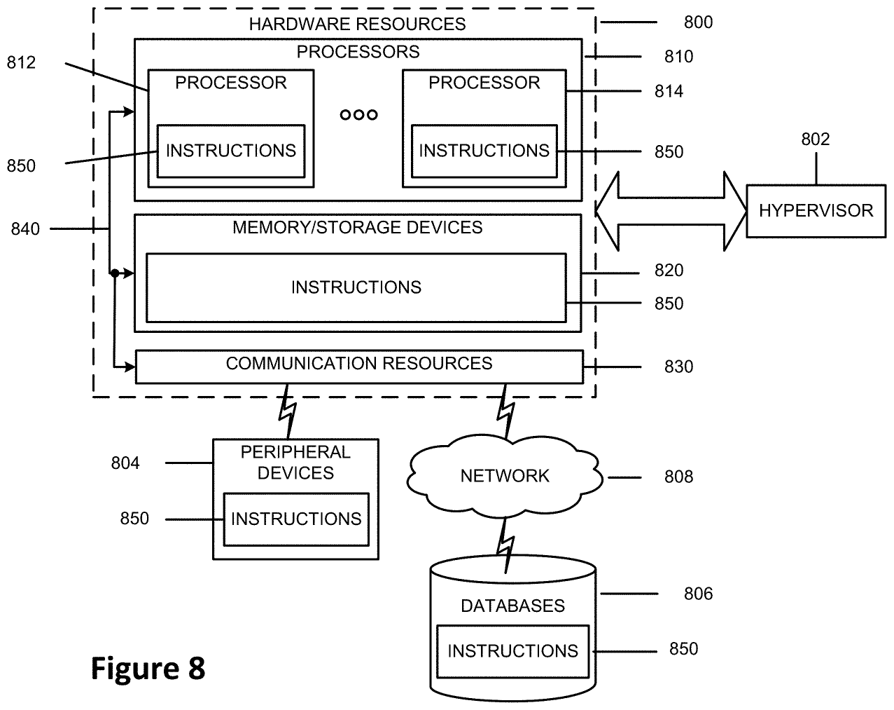

FIG. 8 is a block diagram illustrating components, according to some example embodiments, able to read instructions from a machine-readable or computer-readable medium (for example, a non-transitory machine-readable storage medium) and perform any one or more of the methodologies discussed herein. Specifically, FIG. 8 shows a diagrammatic representation of hardware resources 800 including one or more processors (or processor cores) 810, one or more memory/storage devices 820, and one or more communication resources 830, each of which may be communicatively coupled via a bus 840. For embodiments where node virtualization (for example, network function virtualization (NFV)) is utilized, a hypervisor 802 may be executed to provide an execution environment for one or more network slices/sub-slices to utilize the hardware resources 800.

The processors 810 (for example, a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 812 and a processor 814.

The memory/storage devices 820 may include main memory, disk storage, or any suitable combination thereof. The memory/storage devices 820 may include, but are not limited to, any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 830 may include interconnection or network interface components or other suitable devices to communicate with one or more peripheral devices 804 or one or more databases 806 via a network 808. For example, the communication resources 830 may include wired communication components (for example, for coupling via a Universal Serial Bus (USB)), cellular communication components, NFC components, Bluetooth® components (for example, Bluetooth® Low Energy), Wi-Fi® components, and other communication components.

Instructions 850 may comprise software, a program, an application, an applet, an app, or other executable code for causing at least any of the processors 810 to perform any one or more of the methodologies discussed herein. For example, in an embodiment in which the hardware resources 800 are implemented into the UE 105, the instructions 850 may cause the UE to perform some or all of the operation flow/algorithmic structure 700. In other embodiments, the hardware resources 800 may be implemented into the AN 110. The instructions 850 may cause the AN 110 to perform some or all of the operation flow/algorithmic structure 705. The instructions 850 may reside, completely or partially, within at least one of the processors 810 (for example, within the processor's cache memory), the memory/storage devices 820, or any suitable combination thereof. Furthermore, any portion of the instructions 850 may be transferred to the hardware resources 800 from any combination of the peripheral devices 804 or the databases 806. Accordingly, the memory of processors 810, the memory/storage devices 820, the peripheral devices 804, and the databases 806 are examples of computer-readable and machine-readable media.

Some non-limiting examples of various embodiments are provided below.

Example 1 may include a method of operating a UE, the method comprising: determining a physical random access channel (PRACH) occasion and an associated message A (MsgA) physical uplink shared channel (PUSCH) resource based on a configured slot offset with respect to a two-step random access channel (RACH) procedure in a new radio (NR) network; generating, based on the determined PRACH occasion and associated MsgA PUSCH resource, a MsgA PRACH and PUSCH with respect to the two-step RACH procedure; and transmitting the MsgA PRACH and PUSCH to an access node (AN) with respect to the two-step RACH procedure.

Example 2 may include the method of example 1 or some other example herein, further comprising: decoding, upon reception of a configuration message from the AN, an indication of the configured slot offset, which indicates a time distance from a boundary of the PRACH occasion to the associated MsgA PUSCH resource.

Example 3 may include the method of example 2 or some other example herein, further comprising: determining the PUSCH resource based on the decoded indication of the configured slot offset the PRACH occasion.

Example 4 may include the method of example 2 or some other example herein, wherein the PRACH slot includes one or more preambles and the one or more preambles respectively correspond to one or more PUSCH resource units (PRUs).

Example 5 may include the method of example 1 or some other example herein, further comprising: determining a PRACH resource of the PRACH occasion, based on a path loss with respect to a transmission or reception between the UE and the AN.

Example 6 may include the method of example 5 or some other example herein, further comprising: comparing the path loss with one or more path loss thresholds.

Example 7 determine PRACH resources corresponding to the PRACH occasion, based on one or more reference signal received powers (RSRPs) that are to be compared with one or more RSRP thresholds.

Example 8 may include the method of example 7 or some other example herein, further comprising comparing the one or more RSRPs with one or more RSRP thresholds.

Example 9 may include the method of example 7 or some other example herein, wherein the one or more RSRPs are higher layer filtered RSRPs or layer 1 RSRPs.

Example 10 may include a method of operating an AN, the method comprising: receiving, from an user equipment (UE), a message A (MsgA) that includes a physical random access channel (PRACH) occasion and an associated MsgA physical uplink shared channel (PUSCH) resource with respect to a two-step random access channel (RACH) procedure in a new radio (NR) network; and decoding, upon the reception, information corresponding to the PRACH occasion and the associated MsgA PUSCH resource.

Example 11 may include the method of example 10 or some other example herein, further comprising: generating a configuration message that indicates a slot offset that indicates a time distance from a boundary of the PRACH occasions to the MsgA PUSCH resource; and transmitting the configuration message to the UE.

Example 12 may include a method comprising: determining an initialization seed for demodulation reference signal (DMRS) sequence generation based on one or more parameters that includes random access radio network temporary identifier (RA-RNTI), physical random access channel (PRACH) preamble index, PRACH occasion index, and scrambling ID; generating, based on the determined initialization seed, the DMRS sequence corresponding to a physical uplink shared channel (PUSCH); and transmitting a message A (MsgA) that includes the PUSCH to an access node (AN) in a two-step random access channel (RACH) procedure in a new radio (NR) network.

Example 13 may include the method of example 12 or some other example herein, wherein the DMRS sequence corresponds to a cyclic-prefix orthogonal frequency division multiplexing (CP-OFDM).

Example 14 may include the method of example 13 or some other example herein, wherein the PRACH preamble index corresponds to a plurality of PRACH preambles, and the plurality of PRACH preambles are to be divided into two groups.

Example 15 may include the method of example 13 or some other example herein, wherein the generation of the DMRS sequence is associated with two or more scrambling identifications (IDs).

Example 16 may include the method of example 15 or some other example herein, further comprising: receiving a configuration message that indicates the two or more scrambling IDs via NR minimum system information (MSI), NR remaining minimum system information (RMSI), NR other system information (OSI), or dedicated radio resource control (RRC) signaling; and decoding the two or more scrambling IDs.

Example 17 may include the method of example 16 or some other example herein, wherein a DMRS index with respect to the DMRS sequence is in an order based on DMRS antenna port (AP).

Example 18 may include the method of example 17 or some other example herein, wherein an DMRS index with respect to the DMRS sequence is in the order further or subsequently based on DMRS sequence index.

Example 19 may include a method comprising: receiving, from a user equipment (UE) in a two-step random access channel (RACH) procedure in a new radio (NR) network, a message A (MsgA) that includes a physical uplink shared channel (PUSCH) that includes a demodulation reference signal (DMRS) sequence, wherein the DMRS sequence is generated based on an initialization seed that is determined based on one or more parameters including random access radio network temporary identifier (RA-RNTI), physical random access channel (PRACH) preamble index, PRACH occasion index, and scrambling ID; and decoding the PUSCH.

Example 20 may include the method of example 19 or some other example herein, further comprising generating a configuration message that indicates two or more scrambling identifications (IDs) that are associated with a generation of the DMRS sequence; and transmitting the configuration message to the UE.

Example 21 may include an apparatus comprising means to perform one or more elements of a method described in or related to any of examples 1-20, or any other method or process described herein.

Example 22 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 23 may include an apparatus comprising logic, modules, or circuitry to perform one or more elements of a method described in or related to any of examples 1-20, or any other method or process described herein.

Example 24 may include a method, technique, or process as described in or related to any of examples 1-20, or portions or parts thereof.

Example 25 may include an apparatus comprising: one or more processors and one or more computer-readable media comprising instructions that, when executed by the one or more processors, cause the one or more processors to perform the method, techniques, or process as described in or related to any of examples 1-20, or portions thereof.

Example 26 may include a signal as described in or related to any of examples 1-20, or portions or parts thereof.

Example 27 may include a datagram, packet, frame, segment, protocol data unit (PDU), or message as described in or related to any of examples 1-20, or portions or parts thereof, or otherwise described in the present disclosure.

Example 28 may include a signal encoded with data as described in or related to any of examples 1-20, or portions or parts thereof, or otherwise described in the present disclosure.

Example 29 may include a signal encoded with a datagram, packet, frame, segment, protocol data unit (PDU), or message as described in or related to any of examples 1-20, or portions or parts thereof, or otherwise described in the present disclosure.

Example 30 may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Example 31 may include a computer program comprising instructions, wherein execution of the program by a processing element is to cause the processing element to carry out the method, techniques, or process as described in or related to any of examples 1-20, or portions thereof.

Example 32 may include a signal in a wireless network as shown and described herein.

Example 33 may include a method of communicating in a wireless network as shown and described herein.

Example 34 may include a system for providing wireless communication as shown and described herein.

Example 35 may include a device for providing wireless communication as shown and described herein.

The present disclosure is described with reference to flowchart illustrations or block diagrams of methods, apparatuses (systems) and computer program products according to embodiments of the disclosure. It will be understood that each block of the flowchart illustrations or block diagrams, and combinations of blocks in the flowchart illustrations or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means that implement the function/act specified in the flowchart or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide processes for implementing the functions/acts specified in the flowchart or block diagram block or blocks.

The description herein of illustrated implementations, including what is described in the Abstract, is not intended to be exhaustive or to limit the present disclosure to the precise forms disclosed. While specific implementations and examples are described herein for illustrative purposes, a variety of alternate or equivalent embodiments or implementations calculated to achieve the same purposes may be made in light of the above detailed description, without departing from the scope of the present disclosure, as those skilled in the relevant art will recognize.

What is claimed is:

1. One or more non-transitory, computer-readable media (NTCRM) comprising instructions to, upon execution of the instructions by one or more processors of a user equipment (UE), cause the UE to:
determine a physical random access channel (PRACH) occasion and an associated message A (MsgA) physical uplink shared channel (PUSCH) resource based on a configured slot offset with respect to a two-step random access channel (RACH) procedure in a new radio (NR) network;
generate, based on the determined PRACH occasion and associated MsgA PUSCH resource, a MsgA PRACH and PUSCH with respect to the two-step RACH procedure; and
transmit the MsgA PRACH and PUSCH to an access node (AN) with respect to the two-step RACH procedure.

2. The one or more NTCRM of claim 1, wherein, upon execution, the instructions further cause the UE to decode, upon reception of a configuration message from the AN, an indication of the configured slot offset, which indicates a time distance from a boundary of the PRACH occasion to the associated MsgA PUSCH resource.

3. The one or more NTCRM of claim 2, wherein the UE is to determine the PUSCH resource based on the decoded indication of the configured slot offset the PRACH occasion.

4. The one or more NTCRM of claim 2, wherein the PRACH slot includes one or more preambles and the one or more preambles respectively correspond to one or more PUSCH resource units (PRUs).

5. The one or more NTCRM of claim 1, wherein the instructions, when executed, cause the UE to determine a PRACH resource of the PRACH occasion, based on a path loss with respect to a transmission or reception between the UE and the AN.

6. The one or more NTCRM of claim 5, wherein, upon execution, the instructions further cause the UE to compare the path loss with one or more path loss thresholds.

7. The one or more NTCRM of claim 1, wherein the instructions, when executed, further cause the UE to determine PRACH resources corresponding to the PRACH occasion, based on one or more reference signal received powers (RSRPs) that are to be compared with one or more RSRP thresholds.

8. The one or more NTCRM of claim 7, wherein, upon execution, the instructions further cause the UE to compare the one or more RSRPs with one or more RSRP thresholds.

9. The one or more NTCRM of claim 7, wherein the one or more RSRPs are higher layer filtered RSRPs or layer 1 RSRPs.

10. One or more non-transitory, computer-readable media (NTCRM) comprising instructions to, upon execution of the instructions by one or more processors of an access node (AN), cause the AN to:
receive, from an user equipment (UE), a message A (MsgA) that includes a physical random access channel (PRACH) occasion and an associated MsgA physical uplink shared channel (PUSCH) resource with respect to a two-step random access channel (RACH) procedure in a new radio (NR) network; and
decode, upon the reception, information corresponding to the PRACH occasion and the associated MsgA PUSCH resource.

11. The one or more NTCRM of claim 10, wherein, upon execution, the instructions further cause the AN to:
generate a configuration message that indicates a slot offset that indicates a time distance from a boundary of the PRACH occasions to the MsgA PUSCH resource; and
transmit the configuration message to the UE.

12. An apparatus, comprising:
a central processing unit (CPU) to:
determine an initialization seed for demodulation reference signal (DMRS) sequence generation based on one or more parameters that includes random access radio network temporary identifier (RA-RNTI), physical random access channel (PRACH) preamble index, PRACH occasion index, and scrambling ID, and
generate, based on the determined initialization seed, the DMRS sequence corresponding to a physical uplink shared channel (PUSCH); and
one or more baseband processors coupled with the CPU, to transmit a message A (MsgA) that includes the PUSCH to an access node (AN) in a two-step random access channel (RACH) procedure in a new radio (NR) network.

13. The apparatus of claim 12, wherein the DMRS sequence corresponds to a cyclic-prefix orthogonal frequency division multiplexing (CP-OFDM).

14. The apparatus of claim 13, wherein the PRACH preamble index corresponds to a plurality of PRACH preambles, and the plurality of PRACH preambles are to be divided into two groups.

15. The apparatus of claim 13, wherein the generation of the DMRS sequence is associated with two or more scrambling identifications (IDs).

16. The apparatus of claim 15, wherein,
the one or more baseband processors are further to receive a configuration message that indicates the two or more scrambling IDs via NR minimum system information (MSI), NR remaining minimum system information (RMSI), NR other system information (OSI), or dedicated radio resource control (RRC) signaling; and
the CPU is further to decode the two or more scrambling IDs.

17. The apparatus of claim 16, wherein a DMRS index with respect to the DMRS sequence is in an order based on DMRS antenna port (AP).

18. The apparatus of claim 17, wherein the DMRS index with respect to the DMRS sequence is in the order further or subsequently based on DMRS sequence index.

19. The apparatus of an access node (AN), comprising:
means for receiving, from a user equipment (UE) in a two-step random access channel (RACH) procedure in a new radio (NR) network, a message A (MsgA) that includes a physical uplink shared channel (PUSCH) that includes a demodulation reference signal (DMRS) sequence, wherein the DMRS sequence is generated based on an initialization seed that is determined based on one or more parameters including random access radio network temporary identifier (RA-RNTI), physical random access channel (PRACH) preamble index, PRACH occasion index, and scrambling ID; and
means for decoding the PUSCH.

20. The apparatus of claim 19, further comprising:
means for generating a configuration message that indicates two or more scrambling identifications (IDs) that are associated with a generation of the DMRS sequence; and
means for transmitting the configuration message to the UE.
